(19) United States
(12) Patent Application Publication
(10) Pub. No.: US 2026/0205388 A1
(43) Pub. Date: Jul. 16, 2026

(54) SYSTEMS AND METHODS FOR MANAGING NETWORK CONNECTIONS AND DATA FLOWS DURING CLOUD APPLICATION DEPLOYMENT

(71) Applicant: Capital One Services, LLC, McLean, VA (US)

(72) Inventors: Malay UDESHI, Fairfax, VA (US); Aditya Vikram SINGH, Dallas, TX (US)

(73) Assignee: Capital One Services, LLC, McLean, VA (US)

(21) Appl. No.: 19/025,918

(22) Filed: Jan. 16, 2025

(51) Int. Cl. H04L 43/045; G06F 9/50; G06F 11/34

(52) U.S. Cl. CPC H04L 43/045; G06F 9/5072; G06F 11/3409

(57) ABSTRACT

Systems and methods for managing network connections and data flows during cloud application deployment. For example, the system may retrieve a first network requirement, from a plurality of network requirements, for a first cloud application. The system may determine a first rule set for the first network requirement, wherein the first rule set comprises a first required data feed, of a plurality of required data feeds, and a first required data load. The system may determine a first aggregation weight corresponding to a first performance metric for the first network requirement. The system may modify the first required data load based on the first aggregation weight to generate a first modified rule set. The system may process the first cloud application using the first modified rule set to determine whether to deploy the first cloud application to the first cloud computing network.

### BACKGROUND

Engineering and product teams often face a complex and fragmented ecosystem when it comes to architectural guidance, especially for products and teams utilizing cloud computing systems, because of the sheer diversity and rapidly evolving nature of cloud technologies. The cloud landscape is filled with a multitude of services and providers, each offering distinct capabilities, configurations, and best practices. This diversity can make it difficult for teams to choose the right tools and architectures to meet their specific needs. Additionally, cloud service providers frequently release new features and updates, adding to the complexity of staying current with architectural recommendations. The guidance available often comes from varied sources—each with its own focus and sometimes conflicting priorities—such as vendor documentation, open-source communities, and industry standards. This fragmentation can result in a lack of cohesive, standardized practices, causing teams to expend significant effort in researching, evaluating, and integrating disparate solutions. Furthermore, the need to balance factors like scalability, security, performance, and cost optimization further complicates the decision-making process, as trade-offs must be carefully considered and tailored to each unique project.

To further exacerbate these problems, different applications being created by the various engineering and product teams have different needs and concerns that are specific to the applications. This means that not only do engineering and product teams need to evaluate the various capabilities, configurations, and best practices of various cloud systems and cloud components that are used, but it also means that these engineering and product teams must balance the tradeoffs that these various capabilities, configurations, and best practices create for their specific applications.

### SUMMARY

Systems and methods are described for managing network connections and data flows during cloud application deployment are described herein. In particular, the systems and methods are described for managing network connections and data flows during cloud application deployment based on the plurality of network requirements for the application. For example, prior to application deployment, a plurality of requirements may be thoroughly reviewed to ensure that the application functions as intended and meets both technical and business needs. These requirements include performance and scalability considerations, which involve understanding the expected load on the application and ensuring it can handle peak traffic without degradation. Security requirements must be assessed, including data encryption, secure authentication mechanisms, and adherence to compliance standards. Reliability and availability are also crucial, necessitating the implementation of proper failover mechanisms and monitoring systems to detect and respond to issues promptly. Compatibility and integration requirements may be checked to ensure that the application works seamlessly with other systems and platforms in the environment. Additionally, deployment requirements, such as the necessary infrastructure, automation scripts, and rollback plans, should be reviewed to facilitate a smooth and efficient deployment process. User experience and accessibility may also be evaluated to confirm that the application provides an intuitive and inclusive interface for all users. Lastly, documentation and training materials may be prepared to support ongoing maintenance and future enhancements. Addressing these comprehensive requirements helps mitigate risks and promotes the successful operation of the application in a production environment.

Deploying applications in a cloud landscape that features a multitude of services and providers, each with distinct capabilities, configurations, and best practices, introduces significant technical challenges, especially when individual application requirements must also be met. The diversity and specificity of cloud services mean that teams often face difficult trade-offs, such as choosing between cost efficiency and high performance or balancing flexibility with security. Each decision comes with its own set of implications that can conflict with standardized deployment criteria, making it hard to maintain uniformity across the system. For instance, certain applications may require specialized storage solutions or customized networking configurations that are optimized for performance but may not align with broader organizational standards designed for simplicity and cost control. Additionally, managing these variances can become complex as the infrastructure scales, increasing the risk of misconfigurations, or security vulnerabilities. The need to integrate different services while adhering to deployment best practices—such as automation, monitoring, and compliance—can also lead to fragmented processes and increased operational overhead. This dynamic forces teams to constantly reassess and prioritize their architectural decisions, striving to find a balance between meeting unique application needs and adhering to overarching guidelines and policies, often without a clear-cut solution.

Furthermore, predicting the effects of application deployments is difficult because of the complexity and interconnectedness of modern cloud environments. Applications often depend on numerous microservices, databases, and third-party APIs, creating intricate dependencies that make it challenging to anticipate how a change in one component will impact the entire system. This unpredictability is compounded by variations in workloads, user behavior, and external factors like network conditions, which are hard to model accurately. Moreover, cloud service configurations can behave differently under production-level traffic compared to test environments, making performance testing less reliable. It is technically difficult and time-consuming to simulate realistic conditions that capture all these variables, requiring sophisticated testing frameworks and extensive resources. The need to run comprehensive tests, such as load testing and fault tolerance assessments, further adds to the complexity and cost. Additionally, unforeseen issues, such as resource contention or cascading failures, may only become apparent in production, leading to expensive remediation efforts. Balancing the need for thorough pre-deployment validation with the constraints of time and budget makes the entire process both technically challenging and costly, as teams must invest heavily in both infrastructure and expertise to mitigate these risks effectively.

To overcome these technical deficiencies in balancing the needs for thorough pre-deployment validation with the aforementioned technical challenges, the systems and methods modify the rule set used to a given application requirement by adjusting characteristics of the rule set (e.g., indicating threshold data loads, data types, data sources, and/or testing mechanisms) based on how the performance metrics resulting from the requirement are weighted in an aggregation of the various requirements of the application. For example, according to the performance metric being evaluated, the systems and methods offer a strategic way to balance the need for thorough pre-deployment validation with technical constraints. This approach enables more efficient and targeted testing by focusing resources on the most critical aspects of application performance. For example, if response time is a priority performance metric, higher weights can be assigned to scenarios that simulate peak traffic or stressful data loads, ensuring that testing emphasizes situations most likely to impact user experience. Conversely, less critical metrics can be tested with more streamlined or less resource-intensive methods. By selectively modifying the rule set (and/or specific characteristics therein) based on weighted performance metrics, the system can allocate testing efforts and mechanism more effectively, reducing the time and cost associated with exhaustive validation while still maintaining a high degree of confidence in the system's readiness for deployment. This method provides a pragmatic balance, allowing for deeper testing where it matters most and more efficient validation elsewhere, ultimately optimizing both resource use and application reliability.

Nonetheless, modifying the rule sets for testing application requirements is technically challenging because it requires a deep understanding of the relationships between various performance metrics and the behavior of the application under different conditions. Crafting a rule set that accurately reflects real-world usage scenarios while prioritizing critical metrics involves complex decision-making and careful calibration. Each modification can introduce uncertainties, as changes in data load thresholds or test mechanisms may produce incomplete or misleading results if not carefully balanced. Additionally, the weight attributed to each performance metric must be chosen with precision, requiring extensive knowledge of both the application's architecture and its expected operational environment. Automating and fine-tuning these rule sets further complicates the process, often necessitating sophisticated algorithms and advanced testing frameworks that can adapt to changing requirements. Moreover, maintaining consistency across multiple testing cycles while accommodating the dynamic nature of cloud environments can be difficult, as variations in infrastructure, data sources, or user behavior may alter the effectiveness of a given rule set.

In some aspects, systems and methods for managing network connections and data flows during cloud application deployment are described. For example, the system may receive a first cloud application for network deployment on a first cloud computing network. The system may determine a first application category for the first cloud application. The system may retrieve a plurality of network requirements for the first cloud application based on the first application category, wherein respective performance metrics for each of the plurality of network requirements are aggregated according to predetermined aggregation weights to determine whether to deploy the first cloud application to the first cloud computing network. The system may retrieve a first network requirement, from the plurality of network requirements, for the first cloud application. The system may determine a first rule set for the first network requirement, wherein the first rule set comprises a first required data feed, of a plurality of required data feeds, and a first required data load. The system may determine a first aggregation weight corresponding to a first performance metric for the first network requirement. The system may modify the first required data load based on the first aggregation weight to generate a first modified rule set. The system may process the first cloud application using the first modified rule set to determine whether to deploy the first cloud application to the first cloud computing network.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term, “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a user interface displaying aggregated metrics related to application deployment, in accordance with one or more embodiments.

FIGS. 2A-C show an illustrative diagram for rule sets used testing application requirements, in accordance with one or more embodiments.

FIG. 3 shows illustrative components for a system used to determine rule set modifications in accordance with one or more embodiments.

FIG. 4 shows a flowchart of the steps involved in managing network connections and data flows during cloud application deployment, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

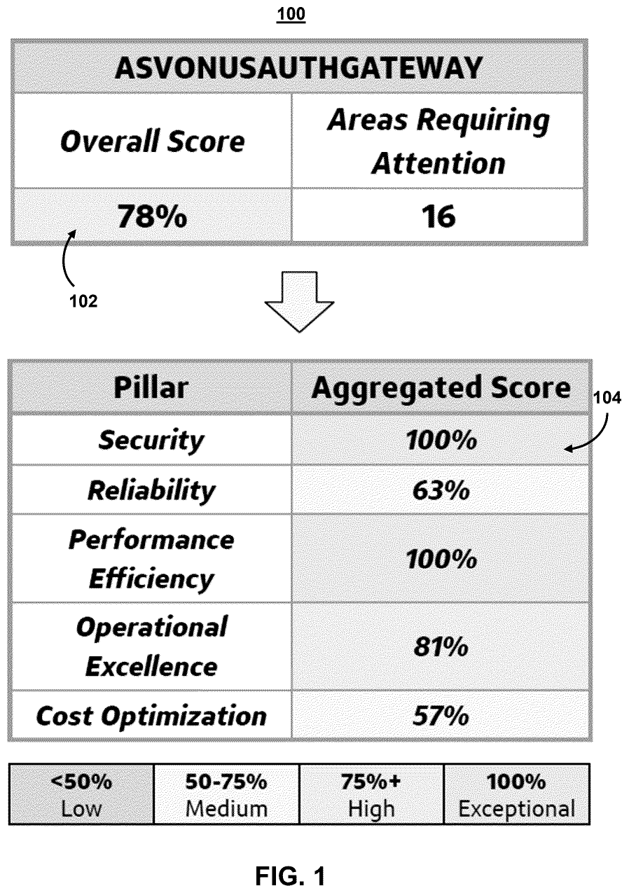

FIG. 1 shows an illustrative diagram for a user interface displaying aggregated metrics related to application deployment, in accordance with one or more embodiments. For example, application deployment is the process of making a software application available for use in a specific environment, such as a testing, staging, or production environment. It may involve a series of coordinated activities that move the application from development to a live setting where end users can access it. This process typically includes packaging the application code, configuring necessary infrastructure components, and executing deployment scripts to ensure the software is correctly installed and operational. Deployment may also involve setting up databases, establishing network configurations, and integrating with other services or systems. Automation tools, such as CI/CD (Continuous Integration and Continuous Deployment) pipelines, may be used to streamline and manage the deployment process, reducing the risk of human error and ensuring consistency across environments. A successful deployment not only delivers the application efficiently but also ensures that it meets performance, security, and reliability standards. Moreover, deployment strategies, such as blue-green deployments or canary releases, are sometimes used to minimize downtime and assess the application's performance before fully releasing it to all users.

To determine whether an application is ready for deployment, the system may generate user interface 100, which includes results for various tests related to application characteristics. For example, the system may create an architecture standard for “Best In Class” cloud solutions for financial services in order to guide well-informed architecture choices and trade-offs for designing secure, performant, intelligent and reliable solutions that incorporate regulatory compliance requirements for financial services. To do so, the system may establish framework layers with a standard set of lexicon and prescriptive guidance for key architecture areas of leverage applicable to banking & financial services. In such cases, the system may measure metrics for architecture fitness functions and best practices embedded into SDLC processes with real-time feedback loop. The system may also include an automated system for maturity assessment (applications, services, and/or platforms) identifying problem areas, potential gaps/opportunities, and makes recommendations for improvement.

As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

To generate user interface 100 that displays overall scores (e.g., aggregated performance metric 102) for an application awaiting deployment. For example, the system may collect and analyze performance metrics from various sources. This data may include metrics related to response time, resource utilization, error rates, and throughput, which are gathered from monitoring tools and performance tests. The system then uses algorithms to aggregate these metrics into a single performance score, often by applying weighted averages or other statistical methods that reflect the relative importance of each metric. The aggregation process may involve normalizing data to ensure comparability and using models that account for correlations between different performance indicators. Once the overall score is determined, the system identifies specific areas that require attention by analyzing deviations from expected performance baselines or thresholds. User interface 100 may then dynamically generate to present this information in an intuitive and visually appealing format, such as charts, graphs, or dashboards. Key insights, like performance bottlenecks or potential risks, are highlighted to help users quickly understand the application's status and areas that need improvement. This allows stakeholders, such as developers and operations teams, to make informed decisions about optimization and maintenance.

Aggregated performance metric 102 may itself be based on respective performance metrics (e.g., performance metric 104) for each of a plurality of network requirements. It should be noted that in some embodiments, each of the respective performance metrics may themselves be aggregated from subsets of performance metrics. For example, the system may generate an aggregated performance metric based on individual performance metrics for each of a plurality of network requirements by first collecting and measuring these metrics across the network. Each performance metric, such as latency, bandwidth usage, packet loss, or jitter, is evaluated to determine how well it meets predefined network performance standards. Once collected, the system normalizes the metrics to ensure they are on a comparable scale, since different metrics may have varying units or levels of significance. The system then applies a weighting scheme to reflect the relative importance of each metric, which is determined based on the specific network requirements and priorities of the application. For example, latency might be weighted more heavily for real-time applications, while bandwidth usage could be a higher priority for data-intensive services. The weighted metrics are combined using statistical techniques, such as a weighted average or a composite scoring model, to produce the aggregated performance metric. This aggregated metric provides a holistic view of the network's overall performance, helping stakeholders understand whether the network meets the desired criteria and where improvements may be necessary. The final score is then used for monitoring, reporting, and decision-making to ensure the network's reliability and efficiency.

As shown in user interface 100, the system may generate performance metrics for categories (or “Pillars”) such as security, reliability, performance efficiency, operational excellence, and/or cost optimization. For example, the system may generate performance metrics for categories like security, reliability, performance efficiency, operational excellence, and cost optimization by collecting relevant data from monitoring tools, system logs, and performance assessments, then analyzing this data according to established criteria for each category. Security metrics may be generated by evaluating factors such as the number of detected vulnerabilities, successful and failed authentication attempts, and the frequency of security patch updates. For example, a security metric might measure the average time taken to patch critical vulnerabilities, with a lower value indicating a more secure system. Reliability metrics may be derived from data-on-system availability, mean time between failures (MTBF), and mean time to recovery (MTTR). For instance, a reliability metric could calculate the uptime percentage over a given period, ensuring the system meets service-level agreements (SLAs). Performance efficiency metrics may involve assessing the responsiveness and resource utilization of an application. The system might track response times for key functions, CPU and memory usage, and throughput. An example of a performance efficiency metric is the average response time of an API endpoint, with lower response times indicating better performance. Operational excellence metrics may be focused on process quality and automation. These metrics include deployment frequency, incident response times, and the percentage of automated workflows. For example, a metric in this category might measure how frequently software updates are successfully deployed without manual intervention, with higher frequencies indicating more operational efficiency. Cost optimization metrics may analyze spending patterns and resource efficiency, often comparing actual expenses to budgeted costs and identifying underutilized resources. An example would be a cost optimization metric that tracks the cost per transaction or the percentage of idle compute resources, highlighting areas where spending can be reduced. By continuously monitoring and calculating these metrics, the system provides insights into each category, helping organizations balance performance, security, reliability, operational practices, and cost efficiency.

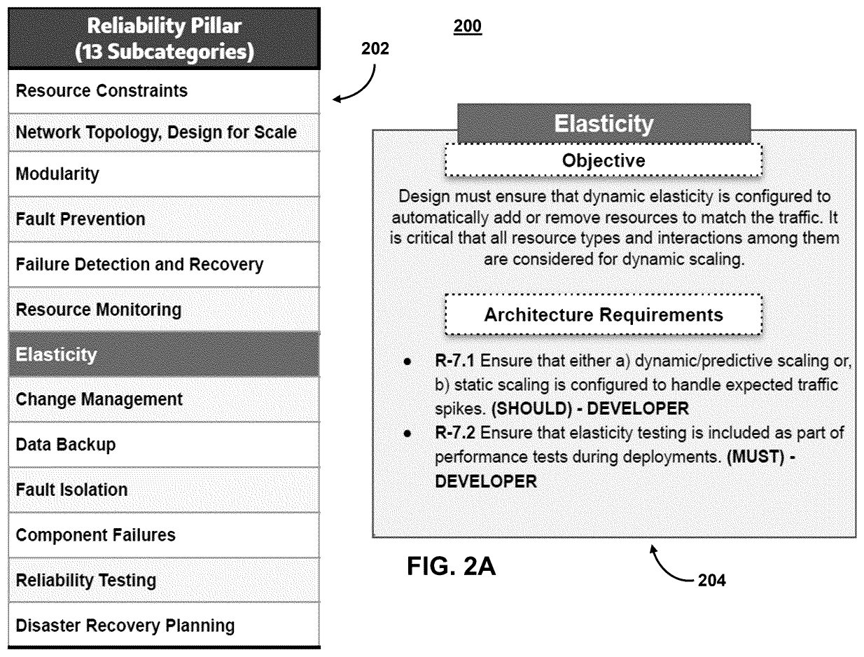

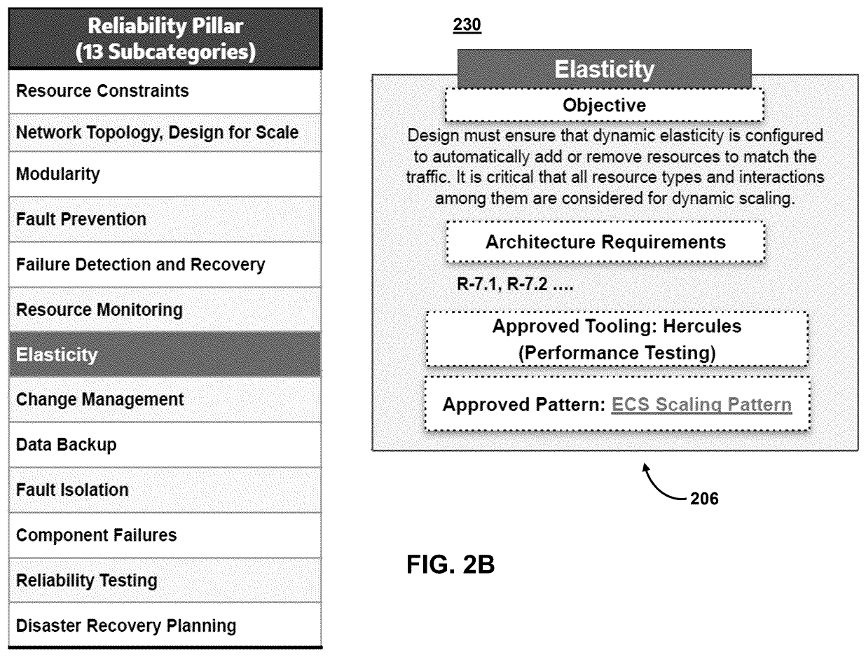

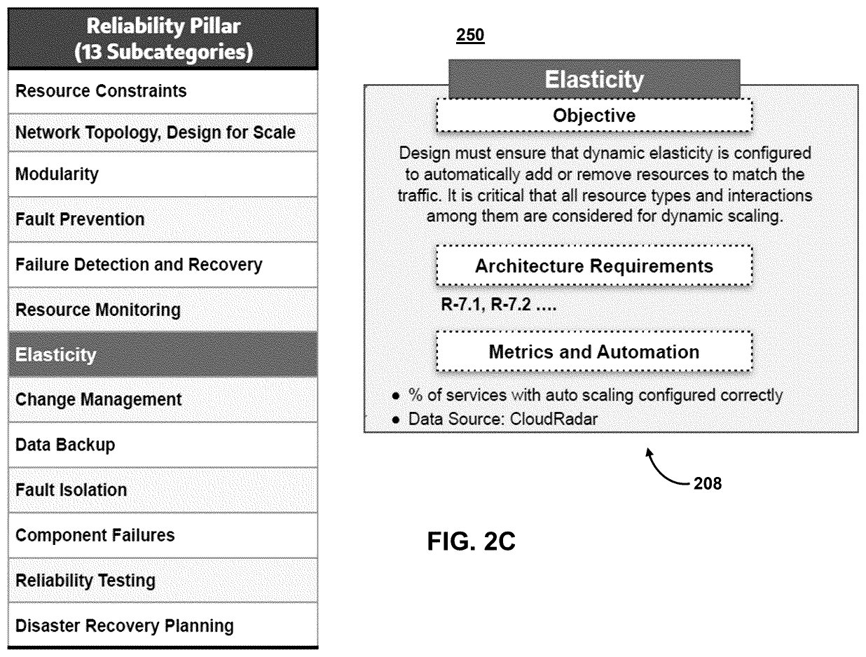

FIGS. 2A-C shows an illustrative diagram for rule sets used testing application requirements, in accordance with one or more embodiments. For example, FIG. 2A shows user interface 200. As shown in FIG. 2A, user interface 200 include a list of network requirements (e.g., network requirements 202) such as “elasticity.” In particular, elasticity is highlighted in box 204. As described in box 204, the system may retrieve the architecture requirements for elasticity.

For example, application and network requirements are specifications that ensure an application runs efficiently, securely, and reliably in its intended environment. These requirements encompass various categories (and/or subcategories) that address the application's design, performance, and operational needs. Elasticity is a key requirement that ensures an application can automatically scale resources up or down to match traffic demands. For instance, a cloud-based e-commerce platform might increase its server capacity during high-traffic events, such as Black Friday, and scale back when traffic decreases. Elasticity is determined by monitoring traffic patterns and configuring autoscaling mechanisms to maintain performance without overprovisioning resources. Resource constraints refer to limitations on system resources like CPU, memory, and storage. An application must be designed to operate efficiently within these constraints, especially in resource-limited environments like edge devices. For example, a mobile app might be optimized to consume minimal memory to prevent crashes on lower-end smartphones. Resource constraints are determined through performance profiling and testing. Network topology involves the arrangement of network elements, such as servers, routers, and data centers. Applications may have specific requirements for network topology to optimize data flow and minimize latency. For example, a content delivery network (CDN) might be used to distribute content geographically to reduce load times for users worldwide. Network topology requirements are determined based on data access patterns and user distribution. Modularity is a design requirement that breaks an application into independent components, making it easier to maintain and update. Microservices architecture, where each service performs a specific function and communicates via APIs, is an example of modularity. This requirement is determined by analyzing the application's complexity and the benefits of isolating components for scalability and maintainability. Fault prevention involves strategies to minimize the risk of errors or failures. For example, implementing input validation and error handling mechanisms helps prevent system crashes. This requirement is determined by assessing potential failure points and designing safeguards to handle unexpected conditions. Failure detection ensures that the system can quickly identify and respond to malfunctions. Health checks and monitoring tools that detect when a service is unresponsive and automatically trigger alerts are examples of failure detection. This requirement is determined by evaluating the criticality of each component and the impact of delays in detection. Resource monitoring tracks the usage of system resources, such as CPU, memory, and bandwidth, to ensure optimal performance. Monitoring dashboards that provide real-time insights into resource utilization help administrators make informed decisions. This requirement is determined by identifying key performance indicators (KPIs) and setting up monitoring tools. Change management is the process of handling updates or changes to the system without disrupting service. This may involve using version control systems and implementing gradual rollouts of new features. The requirement is determined by the frequency and complexity of updates needed and the risk associated with changes.

Data backup ensures that data is regularly saved and can be restored in the event of a failure. For example, a database might be backed up daily to prevent data loss. This requirement is determined by assessing the criticality of the data and the acceptable recovery time objective (RTO) and recovery point objective (RPO). Fault isolation refers to the ability to contain the impact of a failure to a specific component, preventing it from affecting the entire system. Circuit breakers in microservices architectures, which stop calls to a failing service to protect the system, exemplify fault isolation. This requirement is determined by identifying interdependencies between components and potential failure propagation paths. Component failure is a requirement that anticipates and mitigates the impact of individual component failures. Load balancers that redirect traffic from a failed server to healthy ones are a common solution. This requirement is determined by analyzing which components are most likely to fail and the consequences of such failures. Reliability testing involves stress testing and fault injection to ensure the application can handle failures gracefully. For example, chaos engineering tools may be used to simulate failures and observe how the system responds. This requirement is determined by the need for high availability and the tolerance for service disruptions. Disaster recovery ensures that the application can be restored quickly after a catastrophic event. A disaster recovery plan might include redundant data centers in different geographic locations. This requirement is determined by assessing the potential risks and the acceptable downtime for the application. Each of these requirements may be identified through a combination of performance analysis, risk assessment, and understanding the operational environment, ensuring that the application meets both current and future demands.

As shown in FIG. 2B, user interface 230 shows box 206, which further describes the approved tooling and/or approved patterns based on a rule set for determining “elasticity.” The rule set may include characteristics such as a specific tooling mechanism that is approved and/or patterns of data and/or results that may be used to test and/or generate a performance metric.

The system may generate a rule set for testing and generating a performance metric for a given requirement by defining a set of rules and parameters that outline how the testing should be conducted. This process involves selecting specific tools, data patterns, and evaluation criteria that align with the characteristics of the requirement being measured.

For instance, to test and generate a performance metric for latency, the rule set may specify the use of a tool like Apache JMeter for simulating high volumes of traffic and measuring response times under various conditions. The rule set might also define the data patterns, such as a sequence of API calls that mirror real-world user behavior, and specify performance thresholds that must be met, like a maximum response time of 200 milliseconds. Similarly, for a requirement like reliability, the rule set could include guidelines for using chaos engineering tools such as Chaos Monkey to simulate failures and test the system's resilience. It would also outline the criteria for success, such as the system's ability to recover from a simulated failure within a certain time frame.

To create these rule sets, the system uses a combination of predefined standards and custom configurations tailored to the application's needs. The system identifies the most relevant testing mechanisms and data patterns based on the requirement's criticality, the expected environment, and past performance data. These rules ensure consistency in testing while allowing flexibility to adapt to different scenarios. Additionally, the rule set may incorporate logic for analyzing the results, determining whether the performance metric meets the requirement, and generating alerts or recommendations if improvements are needed. Overall, this rule-based approach provides a structured and repeatable method for evaluating performance metrics, ensuring that testing is thorough, relevant, and aligned with the application's objectives.

As shown in FIG. 2C, user interface 250 shows box 208, which further describes the approved metrics and automation based on a rule set for determining “elasticity.” As shown, box 206 may include a percentage of services with auto scaling configured correctly and/or data sources used to determine this. The system determines approved metrics and automation for assessing “elasticity” based on a rule set that defines what constitutes appropriate scaling behavior and the mechanisms for measuring it. The rule set specifies criteria such as the percentage of services that must have auto-scaling correctly configured to meet performance demands efficiently. To achieve this, the system first identifies all the services within the application architecture and examines their auto-scaling configurations, checking parameters like minimum and maximum resource limits, scaling triggers (e.g., CPU utilization thresholds), and cooldown periods between scaling actions.

The system uses monitoring and orchestration tools, such as AWS CloudWatch or Kubernetes Horizontal Pod Autoscaler, to collect real-time data on resource utilization and scaling events. It then cross-references this data with predefined benchmarks from the rule set to determine if the auto-scaling configuration aligns with expected performance requirements. For example, the system might evaluate whether a service's CPU usage consistently triggers scaling actions at the correct thresholds, and whether the scaling adjusts resources efficiently without causing over- or under-provisioning. Additionally, data sources such as historical traffic patterns, resource usage logs, and performance test results are analyzed to verify that the auto-scaling mechanism is effective and responsive to changes in demand. By automating this process, the system ensures that elasticity is continuously monitored and optimized, generating reports or alerts if any services fail to meet the approved metrics. This approach allows for proactive adjustments and helps maintain optimal resource allocation, improving performance, and cost efficiency.

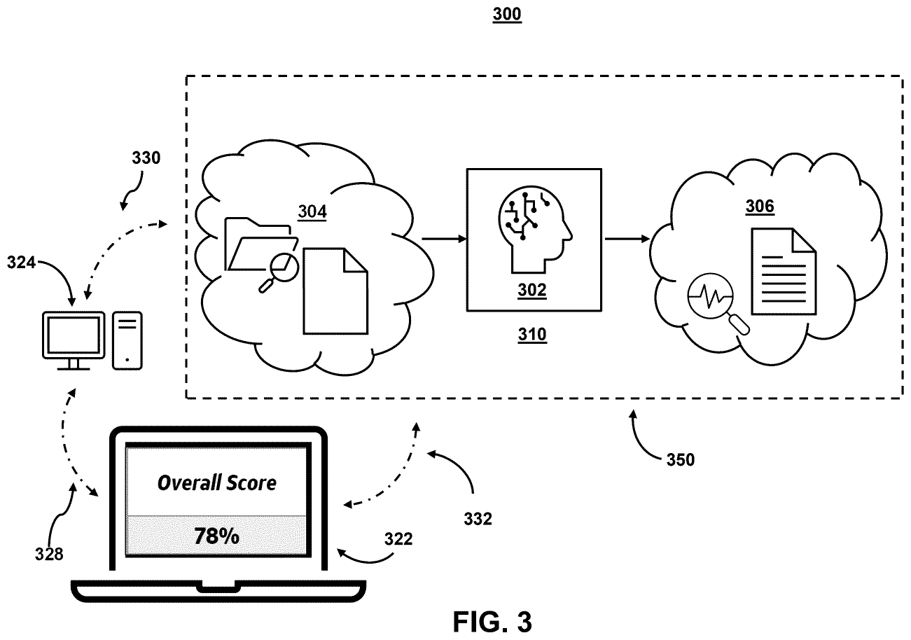

FIG. 3 shows illustrative components for a system used to manage network connections and data flows during cloud application deployment, in accordance with one or more embodiments. For example, FIG. 3 may show illustrative components for managing network connections and data flows during cloud application deployment based on the plurality of network requirements for the application.

For example, modifying the rule sets for testing application requirements is technically challenging because it requires a deep understanding of the relationships between various performance metrics and the behavior of the application under different conditions. Crafting a rule set that accurately reflects real-world usage scenarios while prioritizing critical metrics involves complex decision-making and careful calibration. Each modification can introduce uncertainties, as changes in data load thresholds or test mechanisms may produce incomplete or misleading results if not carefully balanced. Additionally, the weight attributed to each performance metric must be chosen with precision, requiring extensive knowledge of both the application's architecture and its expected operational environment. Automating and fine-tuning these rule sets further complicates the process, often necessitating sophisticated algorithms and advanced testing frameworks that can adapt to changing requirements. Moreover, maintaining consistency across multiple testing cycles, while accommodating the dynamic nature of cloud environments, can be difficult, as variations in infrastructure, data sources, or user behavior may alter the effectiveness of a given rule set.

In some embodiments, an AI model can be used to achieve efficient and adaptive testing for application deployments by automating the process of modifying and optimizing rule sets based on performance metrics. The AI model can analyze historical performance data and learn patterns to predict which configurations are most likely to yield accurate and meaningful results. By leveraging machine learning algorithms, the model can dynamically adjust testing parameters—such as data loads, types, and sources—according to the weight assigned to specific performance metrics. It can prioritize testing scenarios that are most critical to the application's success, ensuring that high-risk areas are thoroughly validated while minimizing unnecessary testing in lower-priority areas. Additionally, AI can help identify correlations and potential performance bottlenecks that might not be obvious through manual analysis, enhancing the reliability of pre-deployment validation. This approach reduces the time and effort required for testing while maintaining a high level of accuracy and adaptability. Furthermore, the AI model can continuously improve its predictions and rule set adjustments over time, becoming more efficient as it gains experience with different deployment scenarios and evolving application requirements.

Using advanced algorithms, the model can detect patterns, trends, and anomalies in performance metrics, resource utilization, or other operational data. These insights are particularly valuable during pre-deployment validation, where the goal is to ensure system reliability and efficiency. By identifying hidden relationships between variables—such as how memory usage affects response times under specific loads—the model can flag potential issues before deployment. For generating recommendations, the system applies optimization techniques and predictive analytics. For instance, it might suggest scaling resources, modifying configurations, or adjusting workload distribution based on patterns it observes in the data. These recommendations are typically generated through a combination of historical data analysis, scenario simulation, and sensitivity testing, enabling the system to propose actionable solutions tailored to the specific environment and goals. Ultimately, this approach helps organizations proactively address issues, improve system performance, and reduce the risk of failure.

On a user interface, recommendations generated by the system would be presented in a clear, actionable, and visually intuitive format to enhance user comprehension and facilitate decision-making. For example, the interface could feature a dashboard with visualizations such as graphs, heatmaps, or performance trend charts highlighting areas of concern. Each recommendation could be accompanied by a concise description, the supporting data or analysis, and the predicted impact of implementing the suggestion. For instance, if the system identifies a bottleneck in memory usage during peak load, the UI might display a graph showing a spike in memory utilization alongside a recommendation like: “Increase memory allocation by 20% during peak hours to reduce response time by 15%.” Additionally, the interface could use color-coded indicators (e.g., red for critical, yellow for warning, green for stable) to prioritize actions. Interactive elements, such as tooltips or expandable sections, could provide further details or allow users to simulate the impact of different recommendations. By combining visual cues with actionable insights, the UI ensures that users can quickly grasp complex data and make informed decisions.

Recommendations can be tailored to positive observations by focusing on opportunities to amplify successful patterns and extend best practices across the system. For instance, if the system detects that a specific configuration leads to optimal performance in a subset of operations, the recommendation could highlight this success and suggest scaling or replicating the approach in other areas. For example, the system might identify that a particular server cluster achieves high throughput with minimal latency under specific load-balancing settings. The recommendation could state: “Current load-balancing strategy has improved throughput by 30%. Consider applying this strategy to additional clusters to enhance overall system efficiency.” Similarly, positive observations about resource utilization or workflow efficiency could be used to propose optimizations, such as consolidating workloads or streamlining processes in areas where similar results might be achieved. By framing recommendations around strengths and opportunities, the system not only identifies improvements but also reinforces practices that contribute to the system's success, encouraging proactive refinement and innovation.

In the context of fault detection and recovery, recommendations can focus on leveraging positive patterns in successful fault-handling scenarios to improve resilience across the system. For example, if the system observes that a particular fault recovery mechanism—such as automatic failover to a backup server—consistently minimizes downtime, it could suggest extending or refining this approach. The recommendation might read: “Automatic failover to backup servers successfully reduced downtime by 95% during recent fault events. Consider implementing similar failover strategies for critical subsystems that currently rely on manual intervention to improve recovery time.” Additionally, if fault logs reveal that specific types of errors are consistently resolved faster due to better diagnostic tools or structured response protocols, the system could propose applying those tools or protocols more broadly. For instance, it might state: “The use of diagnostic tool X reduced resolution times for database errors by 40%. Recommend integrating tool X into workflows for application-level fault recovery to streamline troubleshooting.” These recommendations not only build on observed strengths but also guide the system toward a more proactive, scalable approach to fault management, ultimately enhancing overall system reliability.

For example, cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming, and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

To train an AI model for optimizing rule sets in application testing, a variety of data is required, including historical performance metrics, system logs, resource utilization records, and the results of previous tests. This data helps the model understand how different configurations and conditions impact the application's behavior. The training process typically involves supervised learning, where the model is trained on labeled examples that show the outcomes of various testing scenarios. The model learns to predict the effectiveness of specific rule sets and identify patterns that indicate performance issues or areas requiring more intensive validation. It may also use reinforcement learning, where the model receives feedback based on the success of its testing strategies, gradually learning to make better decisions over time. Common algorithms used include regression models for predicting performance outcomes, clustering techniques for grouping similar testing scenarios, and decision trees or neural networks for optimizing rule set configurations. Advanced models may incorporate techniques like Bayesian optimization or genetic algorithms to efficiently explore and adjust the testing parameters. By using a combination of these algorithms, the AI model becomes adept at selecting and refining rule sets to balance thorough testing with efficiency, continually improving its strategies as more data becomes available.

As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a rule set for a requirement, a modification for a rule set, a weight for a rule set, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a rule set for a requirement, a modification for a rule set, a weight for a rule set, etc.).

In some embodiments, the model (e.g., model 302) may automatically perform actions based on outputs 306. In some embodiments, the model (e.g., model 302) may not perform any actions. The output of the model (e.g., model 302) may be used to determine a rule set for a requirement, a modification for a rule set, a weight for a rule set, etc.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally, or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

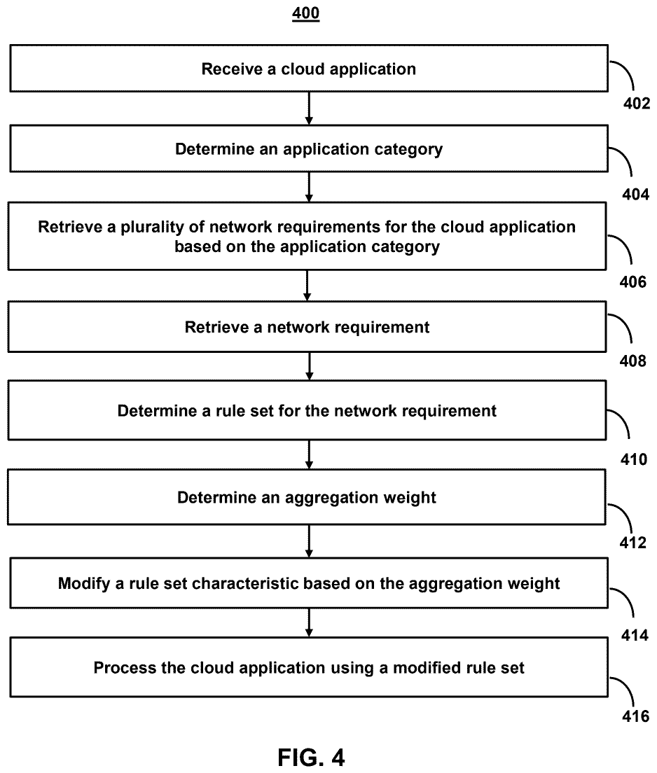

FIG. 4 shows a flowchart of the steps involved in managing network connections and data flows during cloud application deployment, in accordance with one or more embodiments. For example, the system may use process 400 (e.g., as implemented on one or more system components described above) in order to manage network connections and data flows during cloud application deployment based on the plurality of network requirements for the application.

At step 402, process 400 (e.g., using one or more components described above) receives a cloud application. For example, the system may receive a first cloud application for network deployment on a first cloud computing network. In some embodiments, the system may receive a cloud application for deployment by interfacing with the development or source control environment where the application's code and configuration files are hosted. This often involves integrating with version control systems like GitHub, GitLab, or Bitbucket, from which the application's source code, along with infrastructure-as-code (IaC) templates and deployment scripts, can be fetched. The system may also use CI/CD pipelines, where the cloud application is automatically packaged and transferred to the deployment system once the code has passed all necessary tests and quality checks. For instance, when the system is instructed to deploy a first cloud application on a specific cloud computing network, such as AWS, Azure, or Google Cloud Platform, it retrieves the application code and accompanying deployment configurations, such as Docker containers or Kubernetes manifests, that outline how the application should be run in the cloud environment. The system may also receive environment-specific parameters, such as virtual machine sizes, networking settings, and storage configurations, which are necessary for deploying the application on the targeted network infrastructure. Once received, the system prepares the application for deployment by validating the configuration settings, provisioning required cloud resources, and ensuring that dependencies and security credentials are in place for a successful launch. This process enables the system to handle the application efficiently and ensures that it is ready for network deployment in the chosen cloud environment.

In some embodiments, the system may retrieve the plurality of network requirements for the first cloud application based on the first application category by determining a first application characteristic corresponding to the first application category and determining the plurality of network requirements based on the first application characteristic. For example, the system may system retrieves the plurality of network requirements for the first cloud application based on the application category by analyzing key characteristics that define the application's behavior and operational needs. It begins by identifying a first application characteristic that is directly associated with the specified application category. This characteristic might include factors such as the application's expected user load, real-time processing needs, security requirements, or data handling complexity. For example, if the application category is identified as “real-time communication,” the first application characteristic may involve low-latency communication requirements. Using this identified application characteristic, the system then references a knowledge base or configuration repository that maps different application characteristics to corresponding network requirements. The repository includes predefined rules and best practices that dictate which network conditions are necessary to support the specific features and performance expectations of the application. The system cross-references the first application characteristic with these mappings to determine a comprehensive list of network requirements. These requirements could include parameters for bandwidth, latency, security protocols, reliability measures, and more, all tailored to ensure the application can perform optimally in its intended environment. By leveraging this systematic approach, the system ensures that the network requirements retrieved are relevant and aligned with the unique demands of the cloud application, based on its category and specific characteristics. This allows for a customized and effective evaluation process, ultimately aiding in the successful deployment of the application to the cloud computing network.

At step 404, process 400 (e.g., using one or more components described above) determines an application category. For example, the system may determine a first application category for the first cloud application. In some embodiments, the system determines an application category for a cloud application by analyzing various attributes and characteristics of the application, such as its purpose, functionality, architecture, and resource requirements. This categorization process often begins by examining metadata provided with the application, such as tags, descriptors, or labels that developers may have specified. The system may also inspect the application's codebase and configuration files to identify frameworks, programming languages, and dependencies, which provide clues about the application's type. For example, if the application includes APIs and is built using frameworks like Flask or Express.js, the system might categorize it as a “web service” or “API application.” If the application contains features related to data processing or analytics, such as the use of distributed computing frameworks like Apache Spark, it may be classified under “data processing.” Similarly, applications that use machine learning libraries or models would be categorized as “AI/ML applications.” The system may also consider the application's expected load, scaling requirements, and interaction patterns, which can help in classifying it as “real-time,” “batch processing,” or “user-facing.” Machine learning algorithms can also be employed to improve the categorization process by training models on historical data of applications and their categories. By understanding these characteristics, the system assigns the application to an appropriate category, which helps optimize its deployment and management strategies according to the specific needs and best practices associated with that type of application.

For example, the system may apply different rulesets and weights to requirements based on the specifics of the application. The system may user an application profile to determine and category and/other information relating to the application. For example, the system may apply different rulesets and weights to requirements by leveraging application profiles that categorize and define the specific characteristics and context of an application. These profiles include metadata such as the application's purpose, criticality, domain, expected user base, compliance requirements, and resource dependencies. For instance, an application categorized as mission-critical, such as a financial transaction system, may have stricter rules and higher weights assigned to requirements like uptime, data integrity, and security. Conversely, a non-critical internal tool might prioritize ease of deployment and resource efficiency over stringent performance benchmarks.

The system dynamically adjusts its rule set based on the profile by mapping application attributes to predefined policies. For example, it might use the application's domain (e.g., healthcare, e-commerce) to enforce specific compliance checks, such as HIPAA for healthcare or PCI DSS for payment processing. Weights are applied to prioritize certain requirements depending on the application's role; for instance, response time thresholds might carry more significance for customer-facing applications than for batch processing jobs.

By analyzing the application profile, the system tailors its evaluations and decision-making to the application's specific needs. This ensures that the validation process is both comprehensive and context-aware, avoiding a one-size-fits-all approach. It may also provide nuanced recommendations for improvement, such as suggesting enhanced encryption protocols for high-risk applications or resource scaling strategies for those with anticipated high traffic. This adaptability makes the system more efficient and aligned with the diverse operational goals of different applications.

At step 406, process 400 (e.g., using one or more components described above) retrieves a plurality of network requirements for the cloud application based on the application category. For example, the system may retrieve a plurality of network requirements for the first cloud application based on the first application category, wherein respective performance metrics for each of the plurality of network requirements are aggregated according to predetermined aggregation weights to determine whether to deploy the first cloud application to the first cloud computing network. For example, the system may retrieve a plurality of network requirements for a cloud application based on the application category by referencing a predefined database or configuration repository that maps different application categories to their associated network requirements. Once the application category is identified, such as “web service,” “data processing,” or “real-time application,” the system queries this repository to pull a list of network requirements that are critical for the category. These requirements may include parameters like minimum and maximum bandwidth, latency thresholds, security protocols, redundancy measures, and scaling capabilities. For instance, if the cloud application is categorized as a “real-time application,” the system might retrieve stringent requirements for low latency, high availability, and rapid scaling to handle fluctuating user loads. The system then defines respective performance metrics for each network requirement, such as average latency in milliseconds, uptime percentage, or data transfer speed in Mbps. These metrics are monitored and tested during the pre-deployment stage to ensure they align with the desired performance criteria. To determine if the application is ready for deployment, the system aggregates these performance metrics using predetermined aggregation weights. These weights are designed to reflect the relative importance of each requirement, based on the application's category. For example, latency might be given a higher weight for a real-time application, whereas data processing applications may prioritize throughput. The aggregated performance score is then evaluated to decide whether the cloud application meets the necessary network requirements for deployment. If the score falls short of the thresholds, adjustments are made to the configuration or additional optimizations are suggested before proceeding with the deployment.

At step 408, process 400 (e.g., using one or more components described above) retrieves a network requirement. For example, the system may retrieve a first network requirement, from the plurality of network requirements, for the first cloud application. For example, the system may iterate through the various network requirements and/or address each requirement based on a given priority (e.g., based on a weight attributed to the network requirement).

At step 410, process 400 (e.g., using one or more components described above) determines a rule set for the network requirement. For example, the system may determine a first rule set for the first network requirement, wherein the first rule set comprises a first required data feed, of a plurality of required data feeds, and a first required data load. For example, the system may determine a rule set for a network requirement by analyzing the specific parameters and performance criteria associated with that requirement and then generating a comprehensive set of rules that govern how the requirement should be validated and monitored. For example, when addressing a network requirement like latency, the system will reference pre-established guidelines or industry best practices to outline what constitutes acceptable performance. This may involve specifying a data feed, such as real-time traffic simulation data, and defining a data load that appropriately tests the network under expected conditions. The system then establishes detailed rules for data collection and testing. For instance, if the requirement involves ensuring low latency under high-traffic conditions, the rule set may specify the use of a particular monitoring tool that feeds real-time data into the system to simulate network traffic. The first rule set would outline a specific required data feed, such as traffic data representative of peak user activity, and a data load, like a high number of concurrent requests, to adequately stress test the network. These rules ensure that the network's performance is evaluated under realistic and relevant conditions. Additionally, the rule set might define parameters for how often the performance data should be collected and how it should be aggregated or analyzed. It could also include thresholds that must not be exceeded, such as a maximum allowable latency value, and actions to take if performance metrics fall outside acceptable ranges. By detailing these requirements in a rule set, the system can consistently validate the network performance and ensure the application meets its necessary criteria before deployment.

At step 412, process 400 (e.g., using one or more components described above) determines an aggregation weight. For example, the system may determine a first aggregation weight corresponding to a first performance metric for the first network requirement. For example, the system may determine an aggregation weight for a performance metric by assessing the relative importance of the metric in the context of the overall network requirement and the specific needs of the cloud application. This process involves analyzing the criticality of the performance metric in ensuring the application's optimal functionality. For example, if the network requirement pertains to latency for a real-time communication application, the system recognizes that minimizing latency is crucial for user experience and assigns a higher aggregation weight to the latency performance metric. The determination of aggregation weights may also involve consulting predefined policies or using input from domain experts who have outlined the significance of various metrics based on the application's category. The system can use historical data and performance benchmarks to further refine these weights, ensuring that they reflect realistic operational conditions. Additionally, machine learning models may be employed to dynamically adjust aggregation weights by analyzing the impact of each performance metric on overall application performance, especially as usage patterns and environmental factors evolve. In practice, the system assigns a first aggregation weight to a performance metric like latency or bandwidth usage by quantifying how much that metric influences the application's reliability, responsiveness, or cost-efficiency. These weights are then used to aggregate multiple performance metrics into a single composite score that reflects the network's ability to meet the application's requirements. This approach allows the system to prioritize the most critical aspects of network performance, ensuring that key requirements are emphasized when evaluating deployment readiness.

At step 414, process 400 (e.g., using one or more components described above) modifies a rule set characteristic based on the aggregation weight. For example, the system may modify the first required data load based on the first aggregation weight to generate a first modified rule set. For example, the system may modify a rule set characteristic based on the aggregation weight to ensure that testing and performance validation are properly aligned with the criticality of each network requirement. When a performance metric is assigned a higher aggregation weight, it indicates that this metric is of greater importance to the overall success of the application. In response, the system adjusts the rule set to reflect this priority by altering key characteristics, such as the data load used during testing. For example, if the system has determined that latency is a crucial performance metric with a high aggregation weight, it may modify the first required data load to be more rigorous. This adjustment could involve increasing the volume of simulated traffic or the frequency of requests to better stress-test the network and reveal potential performance issues under peak conditions. The idea is to apply more demanding scenarios to ensure the network requirement is met with a higher level of confidence. Conversely, if a metric has a lower aggregation weight, the system might reduce the data load or frequency of testing, conserving resources while still providing adequate validation. By dynamically modifying rule set characteristics based on aggregation weights, the system ensures that resources are allocated efficiently and that critical metrics receive the focus they deserve. This approach enables more targeted and effective testing, improving the likelihood that the application will perform well in production environments while optimizing the use of computational and testing resources.

In some embodiments, the system may modify the first required data load based on the first aggregation weight to generate the first modified rule set by determining a first amount corresponding to the first required data load, determining a reduction to the first amount based on the first aggregation weight, and generating the first modified rule set based on the reduction to the first amount. For example, the system may modify the first required data load based on the first aggregation weight to generate the first modified rule set by carefully adjusting the testing parameters to reflect the importance of the performance metric associated with that weight. First, the system determines the initial amount for the first required data load, which defines the volume or intensity of data that the application will be subjected to during testing. This amount is set to ensure a comprehensive evaluation of the application under standard conditions, such as a specific number of requests per second or a defined volume of simultaneous data transactions. Next, the system evaluates the first aggregation weight, which indicates how critical the associated performance metric is for the overall assessment of the application. If the aggregation weight suggests that the metric is less critical, the system calculates a reduction to the initial data load amount. This reduction is determined based on the weight's value, which dictates the degree to which the data load can be safely decreased without compromising the integrity of the performance evaluation. By reducing the data load, the system optimizes testing efficiency, especially when the metric in question is not a top priority. Finally, the system generates the first modified rule set by incorporating the reduced data load amount. This modified rule set is then used to test the application, ensuring that the testing process is both efficient and aligned with the relative importance of each performance metric. By adjusting the data load based on the aggregation weight, the system balances the need for thorough validation with resource optimization, focusing more rigorous testing efforts on the metrics that matter most while conserving resources where possible.

In some embodiments, the system may generate the first modified rule set by determining a first priority of the first required data feed, determining a threshold priority based on the first aggregation weight, and determining to modify the first required data feed to a second required data feed when generating the first modified rule set based on comparing the first priority to the threshold priority. For example, the system may generate the first modified rule set by adjusting the required data feed based on the priority assigned to it and the relative importance indicated by the first aggregation weight. First, the system assesses the first required data feed, assigning it a priority level based on factors such as the relevance of the data source, the frequency and type of data needed, and the expected impact of the data on the application's performance evaluation. This priority reflects how critical the data feed is in providing accurate and meaningful insights for the specific network requirement being tested. Next, the system uses the first aggregation weight to determine a threshold priority, which serves as a benchmark for deciding whether to modify the data feed. The aggregation weight indicates how important the associated performance metric is in the overall assessment of the application, and this importance is translated into the threshold priority. If the first required data feed has a priority that falls below this threshold, the system concludes that the current data feed may not be optimal for the modified rule set. Based on this comparison, the system may decide to adjust the first required data feed. If the first priority is lower than the threshold priority, the system modifies the rule set by replacing the first required data feed with a second, more appropriate data feed that better aligns with the importance of the performance metric. This new data feed may provide more relevant or higher-quality data, enhancing the reliability of the performance tests. By carefully selecting and adjusting data feeds in this way, the system ensures that the modified rule set effectively balances the need for precise testing with the efficient use of resources, prioritizing data inputs that are most critical for evaluating key performance metrics.

In some embodiments, the system may generate the first modified rule set by determining a first priority of the first required data feed, determining a plurality of data feeds available based on the first priority, and determining to modify the first required data feed to a second required data feed when generating the first modified rule set based on the first required data feed not being available based on the first priority. For example, the system may generate the first modified rule set by assessing the priority and availability of data feeds used for performance testing and making necessary adjustments to ensure testing accuracy and efficiency. It starts by assigning a priority to the first required data feed, which reflects the importance of this data feed in evaluating the application's performance against the network requirement. This priority is determined based on factors like the relevance of the data, the expected impact on test outcomes, and the alignment with the critical performance metrics being assessed. Next, the system identifies a plurality of data feeds that are available and compatible with the testing requirements. It uses the first priority as a guiding factor to filter and select data feeds that can serve as suitable alternatives if needed. The system then checks the availability of the first required data feed within this prioritized set. If the first required data feed is not available, either due to access restrictions, resource constraints, or other issues, the system evaluates the list of alternative data feeds to determine which one can best replace the original feed. The system decides to modify the first required data feed to a second required data feed if the original feed is unavailable. This selection process ensures that the second data feed has a comparable or higher relevance based on the initial priority criteria, maintaining the integrity and effectiveness of the performance tests. By dynamically adjusting the data feeds and generating the modified rule set in this way, the system ensures that testing remains robust and aligned with the application's requirements, even when certain data feeds are not accessible. This flexibility allows the system to adapt to changing conditions while still providing reliable performance evaluations.

In some embodiments, the system may generate the first modified rule set by determining a first network test, in the first rule set, for determining the first performance metric, determining a threshold aggregation weight for performing the first network test, and determining to perform the first network test based on determining that the first aggregation weight meets the threshold aggregation weight. For example, the system may generate the first modified rule set by evaluating the necessity and relevance of performing specific network tests based on the aggregation weight assigned to performance metrics. It begins by identifying the first network test defined in the original rule set, which is used to measure a particular performance metric, such as latency, bandwidth efficiency, or error rate. This network test is designed to evaluate the application's ability to meet the network requirement under certain conditions, such as high traffic loads or varying data patterns. Next, the system determines a threshold aggregation weight that serves as a criterion for deciding whether the network test is essential. This threshold is based on the importance of the performance metric to the overall assessment of the application. Metrics that are critical to the application's success, such as those directly impacting user experience or system stability, typically have higher threshold weights. The system then compares the first aggregation weight, which indicates the significance of the corresponding performance metric, against this threshold aggregation weight. If the first aggregation weight meets or exceeds the threshold, the system concludes that the first network test is crucial and must be performed to ensure a thorough evaluation of the application's performance. As a result, the first modified rule set includes instructions to conduct the network test. On the other hand, if the first aggregation weight is below the threshold, the system may decide to omit or simplify the network test to optimize testing resources. This approach ensures that testing efforts are prioritized for the most important performance metrics, balancing the need for comprehensive validation with the efficient use of resources. By dynamically adjusting the rule set based on aggregation weights, the system can maintain a strategic focus on critical performance aspects, enhancing the reliability and effectiveness of the testing process.

In some embodiments, the system may generate the first modified rule set by determining a first network test, in the first rule set, for determining the first performance metric, determining a threshold aggregation weight for performing the first network test, and determining to perform a second network test instead of the first network test based on determining that the first aggregation weight does not meet the threshold aggregation weight. For example, the system may generate the first modified rule set by strategically adapting the network tests to prioritize efficiency while maintaining performance assessment accuracy. It starts by identifying the first network test outlined in the original rule set, which is designed to evaluate a specific performance metric, such as latency or resource utilization, under certain testing conditions. This network test is typically chosen to provide a comprehensive evaluation of the metric, but it may be resource-intensive or time-consuming. The system then establishes a threshold aggregation weight, which serves as a benchmark to determine whether the first network test is necessary. This threshold is based on the relative importance of the performance metric, with higher weights indicating metrics that are critical to the application's overall performance and lower weights indicating metrics of lesser importance. The system compares the first aggregation weight assigned to the performance metric with the threshold aggregation weight. If the first aggregation weight does not meet the threshold, the system determines that the first network test may be too resource-intensive or unnecessary for evaluating a less critical metric. In response, the system selects a second, more efficient network test to replace the first one. The second network test is designed to provide adequate performance evaluation while using fewer resources or simplifying the testing process. This substitution ensures that testing remains effective but is optimized for metrics that are not prioritized as highly. By modifying the rule set in this way, the system ensures that testing resources are allocated efficiently, focusing more rigorous testing efforts on high-priority metrics, and using streamlined tests for metrics with lower significance. This approach helps maintain a balance between thorough performance validation and resource optimization, ensuring that the application is assessed appropriately without unnecessary overhead.

In some embodiments, the system may generate the first modified rule set by determining a first data type, in the first rule set, for determining the first performance metric, determining a threshold aggregation weight for using the first data type, and determining to use a second data type instead of the first data type based on determining that the first aggregation weight does not meet the threshold aggregation weight. For example, the system may generate the first modified rule set by dynamically adjusting the data type used for testing based on the relative importance of the performance metric. It begins by identifying the first data type specified in the original rule set, which is intended to be used for evaluating a particular performance metric, such as response time, resource efficiency, or error rate. The choice of this first data type is typically designed to provide comprehensive and realistic testing results, but it may involve complex or resource-intensive data sets. The system then determines a threshold aggregation weight that indicates the level of importance required for using the first, more detailed data type. This threshold reflects the criticality of the performance metric, with higher weights assigned to metrics that are crucial for the application's overall performance and lower weights for metrics that are less impactful. By comparing the first aggregation weight of the performance metric to the threshold aggregation weight, the system assesses whether the use of the first data type is justified. If the first aggregation weight does not meet the threshold, indicating that the performance metric is of lower priority, the system decides to replace the first data type with a second, simpler data type. The second data type is chosen to provide a more efficient and less resource-intensive way of testing, while still yielding sufficient insight into the performance metric. This adjustment allows the system to streamline the testing process and conserve resources, without compromising the overall effectiveness of the performance evaluation. By modifying the rule set to use a more appropriate data type based on the aggregation weight, the system ensures that testing remains efficient and targeted. High-priority metrics continue to be tested with comprehensive data types, while lower-priority metrics are evaluated using simpler data, optimizing the use of computational and testing resources while still providing meaningful performance assessments.

At step 416, process 400 (e.g., using one or more components described above) processes the cloud application using a modified rule set. For example, the system may process the first cloud application using the first modified rule set to determine whether to deploy the first cloud application to the first cloud computing network. For example, the system may process the cloud application using a modified rule set by applying the updated testing and validation parameters to evaluate the application's performance and readiness for deployment. Once the rule set has been modified—such as increasing the data load for critical metrics based on aggregation weights—the system uses this rule set to simulate real-world conditions that the application is expected to encounter. This process involves running performance tests, security checks, and stress tests according to the specified criteria, which may include higher traffic volumes, more rigorous security assessments, or additional fault tolerance evaluations. As the cloud application is tested, the system collects performance metrics and compares them against the thresholds and requirements defined in the modified rule set. For example, if the rule set specifies a higher data load to test scalability, the system will assess whether the application can maintain acceptable latency, response times, and resource efficiency under those conditions. The system then aggregates the results of these tests and determines if the application meets the necessary standards to ensure reliable and efficient operation in the target cloud computing network. If the cloud application passes all the tests and meets or exceeds the requirements defined by the modified rule set, the system approves it for deployment. If the application fails to meet any of the critical thresholds, the system may flag it for further optimization or configuration adjustments. This approach ensures that only applications that have been thoroughly validated and are ready to handle expected demands are deployed, reducing the risk of performance issues or failures in the live environment.

In some embodiments, the system can use a modified rule set to determine whether to deploy an application by defining specific criteria that reflect the organization's deployment standards, such as performance benchmarks, security compliance, resource utilization thresholds, and functional integrity. These rules, often encoded into a decision-making framework or policy engine, assess the readiness of an application for deployment. For example, the system might evaluate metrics like response times, error rates, and compatibility with the platform environment, only allowing deployment if all conditions are met or providing a detailed report on why the criteria were not satisfied.

Using this framework, the system can perform automated assessments at the application, domain, and platform levels by applying tailored rule sets to each layer. At the application level, it might check for bugs, memory leaks, or adherence to coding standards. At the domain level, it could validate that the application aligns with specific business logic, data flow integrity, and compliance requirements. At the platform level, the system might evaluate infrastructure compatibility, scalability, and resource availability. By integrating these assessments into a unified framework, the system provides comprehensive evaluations that ensure consistency across all levels of deployment.

To offer real-time feedback as applications are built, the system can integrate with development pipelines and continuous integration/continuous deployment (CI/CD) tools. It monitors code changes, performs automated testing, and validates configurations against the rule set as developers work. When issues are detected—such as a security vulnerability or a performance degradation—the system immediately flags them and provides actionable corrective suggestions. For instance, it might highlight inefficient database queries and recommend optimization techniques or point out missing dependencies and suggest fixes. This real-time feedback loop helps developers address issues proactively, ensuring that applications meet deployment standards and reducing delays caused by post-development remediation.

In some embodiments, the system may process the first cloud application using the first modified rule set to determine whether to deploy the first cloud application to the first cloud computing network by determining the first performance metric by processing the first cloud application using the first modified rule set, determining a threshold metric for deploying the first cloud application, and comparing the first performance metric to the threshold metric. For example, the system may process the first cloud application using the first modified rule set to decide whether to deploy it to the first cloud computing network by executing a series of evaluation steps. First, it applies the modified rule set, which includes the updated testing parameters such as data load, security measures, and performance benchmarks, to simulate real-world scenarios. During this testing phase, the system actively monitors and collects performance metrics for the cloud application. For example, it measures critical metrics like response time, resource utilization, error rates, and scalability under the specified conditions outlined in the modified rule set. Next, the system determines a threshold metric that defines the minimum acceptable performance standard for deployment. This threshold metric is based on the network and application requirements, ensuring that the application can handle its expected workload efficiently and reliably. Once the performance data is collected, the system compares the first performance metric—such as the measured response time or throughput—against the predetermined threshold metric. If the first performance metric meets or exceeds the threshold, indicating that the application performs adequately under the modified test conditions, the system approves it for deployment to the cloud computing network. However, if the first performance metric falls short of the threshold metric, the system may flag the application for further analysis and optimization. This could involve adjusting the configuration, improving resource allocation, or addressing performance bottlenecks before another round of testing is conducted. By systematically comparing the performance metric to the threshold, the system ensures that only applications capable of meeting critical performance standards are deployed, reducing the likelihood of issues in the live environment and enhancing overall reliability.

In some embodiments, the system may process the first cloud application using the first modified rule set to determine whether to deploy the first cloud application to the first cloud computing network by determining the first performance metric by processing the first cloud application using the first modified rule set and weighting the first performance metric based on the first aggregation weight to determine a first weighted performance metric. For example, the system may process the first cloud application using the first modified rule set to determine whether to deploy it to the first cloud computing network by executing a detailed evaluation process that incorporates weighting mechanisms. First, the system applies the modified rule set to test the cloud application under conditions that reflect real-world usage. This rule set includes specific parameters, such as increased data loads, enhanced security checks, or stress testing scenarios, that were adjusted based on the application's requirements. During this testing, the system collects various performance metrics, such as latency, throughput, or resource efficiency, as defined by the rule set. Once the first performance metric is determined—for example, the application's average response time under peak load—the system applies the first aggregation weight to this metric. The aggregation weight reflects the criticality of the metric relative to the overall performance evaluation, ensuring that more important metrics have a greater impact on the final assessment. By multiplying or otherwise adjusting the first performance metric with the assigned aggregation weight, the system generates a first weighted performance metric. This weighting process allows the system to prioritize metrics that are more crucial to the application's success and overall performance. The system then uses the first weighted performance metric to make a deployment decision. If the weighted metric meets or exceeds the acceptable performance threshold, the application is deemed ready for deployment. If not, the system may recommend further optimization or adjustments to ensure the application can handle the demands of the cloud environment. By weighting performance metrics based on their significance, the system ensures that critical performance aspects are given appropriate consideration in the deployment decision, thereby improving the reliability and efficiency of the application in production.

In some embodiments, the system may process the first cloud application using the first modified rule set to determine whether to deploy the first cloud application to the first cloud computing network by determining a first weighted performance metric for the first cloud application based on weighting the first performance metric based on the first aggregation weight, determining a second weighted performance metric for the first cloud application based on weighting a second performance metric based on a second aggregation weight, and generating an aggregated performance metric based on aggregating the first weighted performance metric and the second weighted performance metric. For example, the system may process the first cloud application using the first modified rule set to evaluate its readiness for deployment to the first cloud computing network through a structured performance assessment and aggregation process. First, the system tests the cloud application using the parameters defined in the modified rule set, collecting multiple performance metrics that are crucial to the application's operation. It then calculates a first weighted performance metric by taking the initial performance measurement—such as response time, resource utilization, or availability—and applying the first aggregation weight. This weight reflects the importance of that particular metric, ensuring that metrics critical to the application's functionality carry more significance in the overall evaluation. Next, the system determines a second weighted performance metric by evaluating another key aspect of the application, such as throughput or error rate, and applying a second aggregation weight to this metric. The second weight reflects the relative importance of this metric in the broader context of the application's requirements. By assigning different weights to each performance metric, the system prioritizes metrics based on how they impact the application's performance and reliability. Finally, the system generates an aggregated performance metric by combining the first and second weighted performance metrics. This aggregation could be performed using methods such as weighted averages or composite scoring models to ensure a holistic assessment of the application's performance. The resulting aggregated performance metric provides a comprehensive evaluation that balances all critical performance aspects, allowing the system to make an informed decision about whether the cloud application meets the necessary standards for deployment. If the aggregated score satisfies the predefined thresholds, the application is approved for deployment. If not, the system may suggest optimizations or adjustments to improve performance before re-evaluation. This approach ensures that the application is robust, efficient, and well-suited for the target cloud environment.

In some embodiments, the system may process the first cloud application using the first modified rule set to determine whether to deploy the first cloud application to the first cloud computing network by determining a first weighted performance metric for the first cloud application based on weighting the first performance metric based on the first aggregation weight, determining a second weighted performance metric for the first cloud application based on weighting a second performance metric based on a second aggregation weight, and generating for display, in a user interface, a first visualization comprising the first weighted performance metric and the second weighted performance metric. For example, the system may process the first cloud application using the first modified rule set to determine whether to deploy it to the first cloud computing network by executing a detailed performance analysis and creating a visual representation of the results. First, the system runs the cloud application through a series of tests defined by the modified rule set, collecting key performance metrics that are essential for evaluating the application's suitability for deployment. It then calculates a first weighted performance metric by applying the first aggregation weight to the initial performance measurement. This step ensures that more critical metrics, such as response time or scalability, are given greater significance in the overall assessment. Next, the system determines a second weighted performance metric by evaluating another aspect of the application's performance, such as error rate or resource efficiency, and applying a second aggregation weight. This weight is configured based on the relative importance of the metric, ensuring that each metric's impact is appropriately reflected. Both the first and second weighted performance metrics are then used to provide a comprehensive view of how the application performs under the specified conditions. To facilitate decision-making, the system generates a first visualization in a user interface (e.g., as shown in FIG. 1) that displays these weighted performance metrics. This visualization may include charts, graphs, or dashboards that clearly illustrate the values of the first and second weighted performance metrics, highlighting their significance and how they compare to acceptable thresholds. By presenting the data visually, the system enables users, such as developers or operations teams, to quickly assess the application's performance and make informed decisions about whether to proceed with deployment. This visual representation makes complex performance data accessible and actionable, providing a clear understanding of whether the application meets the required standards for the cloud environment.

In some embodiments, the system may process the first cloud application using the first modified rule set to determine whether to deploy the first cloud application to the first cloud computing network by determining the first performance metric by processing the first cloud application using the first modified rule set, determining a first field in a first visualization corresponding to the first network requirement, and populating the first field in the first visualization with the first performance metric. For example, the system may process the first cloud application using the first modified rule set to determine whether it is ready for deployment to the first cloud computing network by executing a series of performance evaluations and presenting the results in a user-friendly visualization. First, the system runs the cloud application using the parameters specified in the modified rule set, which includes factors like increased data load, enhanced security checks, or more stringent performance criteria. During this process, the system collects the first performance metric, which could be a measurement of latency, resource utilization, or response time, depending on the network requirement being tested. Next, the system determines how to represent this performance metric in a visual format by identifying a corresponding field in a user interface designed for performance review. It selects a first field in the visualization that is specifically designated for displaying metrics related to the first network requirement. This field could be part of a dashboard or a graph that shows how well the application meets the set criteria. The system then populates this first field in the visualization with the collected first performance metric. For example, if the performance metric is latency, the field may display the value in milliseconds, potentially accompanied by color coding or other visual indicators that signify whether the metric meets or falls short of the acceptable threshold. By presenting the performance metric in a clear and intuitive format, the system enables stakeholders, such as developers or network administrators, to quickly assess the application's readiness for deployment and make data-driven decisions. This visual approach simplifies the interpretation of performance data, making it easier to identify areas that may need optimization before the application is deployed to the cloud computing network.

In some embodiments, the system may perform multiple iterations of the network requirement tests or simultaneously process multiple network requirements. For example, the system may do this by retrieving a second network requirement, from the plurality of network requirements, for the first cloud application, determining a second rule set for the first network requirement, wherein the second rule set comprises a second required data feed, of the plurality of required data feeds, and a second required data load, determining a second aggregation weight corresponding to a second performance metric for the second network requirement, modifying the second required data load based on the second aggregation weight to generate a second modified rule set, and processing the first cloud application using the second modified rule set to determine whether to deploy the first cloud application to the first cloud computing network.

For example, the system may first retrieve a second network requirement from the list of requirements associated with the application. This second network requirement may pertain to a different performance aspect, such as bandwidth, reliability, or security, which must also be validated before deployment. The system then identifies or determines a second rule set for testing this network requirement. This second rule set includes a second required data feed and a second required data load, which are tailored to simulate the conditions necessary for evaluating the specific performance metric associated with the second network requirement. The system then assesses the importance of the second performance metric by determining a second aggregation weight. Similar to the process used for the first network requirement, this aggregation weight indicates how critical the second performance metric is in the overall evaluation of the application's readiness for deployment. If the second aggregation weight suggests that the performance metric is of high importance, the system may increase the second required data load to ensure a rigorous testing scenario. Conversely, if the second aggregation weight is lower, the system modifies the data load to optimize resource usage and testing efficiency, generating a second modified rule set that reflects these adjustments. Once the second modified rule set is prepared, the system processes the first cloud application using the new parameters, running tests that evaluate the application's performance relative to the second network requirement. By executing these tests concurrently or in multiple iterations, the system can comprehensively assess how the application performs under different network conditions, ensuring that all critical metrics are evaluated before making a deployment decision. This parallel or iterative approach enables the system to gather extensive performance data efficiently, allowing stakeholders to make informed decisions about deploying the cloud application to the network.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for managing network connections and data flows during cloud application deployment.
2. The method of the preceding embodiment, further comprising: receiving a first cloud application for network deployment on a first cloud computing network; determining a first application category for the first cloud application; retrieving a plurality of network requirements for the first cloud application based on the first application category, wherein respective performance metrics for each of the plurality of network requirements are aggregated according to predetermined aggregation weights to determine whether to deploy the first cloud application to the first cloud computing network; retrieving a first network requirement, from the plurality of network requirements, for the first cloud application; determining a first rule set for the first network requirement, wherein the first rule set comprises a first required data feed, of a plurality of required data feeds, and a first required data load; determining a first aggregation weight corresponding to a first performance metric for the first network requirement; modifying the first required data load based on the first aggregation weight to generate a first modified rule set; and processing the first cloud application using the first modified rule set to determine whether to deploy the first cloud application to the first cloud computing network.
3. The method of any one of the preceding embodiments, wherein processing the first cloud application using the first modified rule set to determine whether to deploy the first cloud application to the first cloud computing network further comprises: determining the first performance metric by processing the first cloud application using the first modified rule set; determining a threshold metric for deploying the first cloud application; and comparing the first performance metric to the threshold metric.
4. The method of any one of the preceding embodiments, wherein processing the first cloud application using the first modified rule set to determine whether to deploy the first cloud application to the first cloud computing network further comprises: determining the first performance metric by processing the first cloud application using the first modified rule set; and weighting the first performance metric based on the first aggregation weight to determine a first weighted performance metric.
5. The method of any one of the preceding embodiments, wherein processing the first cloud application using the first modified rule set to determine whether to deploy the first cloud application to the first cloud computing network further comprises: determining a first weighted performance metric for the first cloud application based on weighting the first performance metric based on the first aggregation weight; determining a second weighted performance metric for the first cloud application based on weighting a second performance metric based on a second aggregation weight; and generating an aggregated performance metric based on aggregating the first weighted performance metric and the second weighted performance metric.
6. The method of any one of the preceding embodiments, wherein processing the first cloud application using the first modified rule set to determine whether to deploy the first cloud application to the first cloud computing network further comprises: determining a first weighted performance metric for the first cloud application based on weighting the first performance metric based on the first aggregation weight; determining a second weighted performance metric for the first cloud application based on weighting a second performance metric based on a second aggregation weight; and generating for display, in a user interface, a first visualization comprising the first weighted performance metric and the second weighted performance metric.
7. The method of any one of the preceding embodiments, wherein processing the first cloud application using the first modified rule set to determine whether to deploy the first cloud application to the first cloud computing network further comprises: determining the first performance metric by processing the first cloud application using the first modified rule set; determining a first field in a first visualization corresponding to the first network requirement; and populating the first field in the first visualization with the first performance metric.
8. The method of any one of the preceding embodiments, wherein modifying the first required data load based on the first aggregation weight to generate the first modified rule set further comprises: determining a first amount corresponding to the first required data load; determining a reduction to the first amount based on the first aggregation weight; and generating the first modified rule set based on the reduction to the first amount.
9. The method of any one of the preceding embodiments, wherein generating the first modified rule set further comprises: determining a first priority of the first required data feed; determining a threshold priority based on the first aggregation weight; and determining to modify the first required data feed to a second required data feed when generating the first modified rule set based on comparing the first priority to the threshold priority.
10. The method of any one of the preceding embodiments, wherein generating the first modified rule set further comprises: determining a first priority of the first required data feed; determining a plurality of data feeds available based on the first priority; and determining to modify the first required data feed to a second required data feed when generating the first modified rule set based on the first required data feed not being available based on the first priority.
11. The method of any one of the preceding embodiments, wherein generating the first modified rule set further comprises: determining a first network test, in the first rule set, for determining the first performance metric; determining a threshold aggregation weight for performing the first network test; and determining to perform the first network test based on determining that the first aggregation weight meets the threshold aggregation weight.
12. The method of any one of the preceding embodiments, wherein generating the first modified rule set further comprises: determining a first network test, in the first rule set, for determining the first performance metric; determining a threshold aggregation weight for performing the first network test; and determining to perform a second network test instead of the first network test based on determining that the first aggregation weight does not meet the threshold aggregation weight.
13. The method of any one of the preceding embodiments, wherein generating the first modified rule set further comprises: determining a first data type, in the first rule set, for determining the first performance metric; determining a threshold aggregation weight for using the first data type; and determining to use a second data type instead of the first data type based on determining that the first aggregation weight does not meet the threshold aggregation weight.
14. The method of any one of the preceding embodiments, further comprising: retrieving a second network requirement, from the plurality of network requirements, for the first cloud application; determining a second rule set for the first network requirement, wherein the second rule set comprises a second required data feed, of the plurality of required data feeds, and a second required data load; determining a second aggregation weight corresponding to a second performance metric for the second network requirement; modifying the second required data load based on the second aggregation weight to generate a second modified rule set; and processing the first cloud application using the second modified rule set to determine whether to deploy the first cloud application to the first cloud computing network.
15. The method of any one of the preceding embodiments, wherein retrieving the plurality of network requirements for the first cloud application based on the first application category further comprises: determining a first application characteristic corresponding to the first application category; and determining the plurality of network requirements based on the first application characteristic.
16. One or more non-transitory, computer-readable mediums storing instructions that, when executed by a data processing apparatus, cause the data processing apparatus to perform operations comprising those of any of embodiments 1-16.
17. A system comprising one or more processors; and memory storing instructions that, when executed by the processors, cause the processors to effectuate operations comprising those of any of embodiments 1-16.
18. A system comprising means for performing any of embodiments 1-16.

What is claimed is:

1. A system for generating real-time visualizations of cloud application characteristics by managing network connections and data flows during cloud application deployment, the system comprising:
receiving a first cloud application for network deployment on a first cloud computing network;
determining a first application category for the first cloud application;
retrieving a plurality of network requirements for the first cloud application based on the first application category, wherein respective performance metrics for each of the plurality of network requirements are aggregated according to predetermined aggregation weights to determine whether to deploy the first cloud application to the first cloud computing network;
retrieving a first network requirement, from the plurality of network requirements, for the first cloud application;
determining a first rule set for the first network requirement, wherein the first rule set comprises a first required data feed, of a plurality of required data feeds, and a first required data load;
determining a first aggregation weight corresponding to a first performance metric for the first network requirement;
modifying the first required data load based on the first aggregation weight to generate a first modified rule set;
processing the first cloud application using the first modified rule set to determine the first performance metric; and
generating for display, in a user interface, a first visualization of a first cloud application characteristic for the first cloud application based on the first performance metric simultaneously with respective visualizations for other cloud application characteristics for the first cloud application.

2. A method for managing network connections and data flows during cloud application deployment, the method comprising:
receiving a first cloud application for network deployment on a first cloud computing network;
determining a first application category for the first cloud application;
retrieving a plurality of network requirements for the first cloud application based on the first application category, wherein respective performance metrics for each of the plurality of network requirements are aggregated according to predetermined aggregation weights to determine whether to deploy the first cloud application to the first cloud computing network;
retrieving a first network requirement, from the plurality of network requirements, for the first cloud application;
determining a first rule set for the first network requirement, wherein the first rule set comprises a first required data feed, of a plurality of required data feeds, and a first required data load;
determining a first aggregation weight corresponding to a first performance metric for the first network requirement;
modifying the first required data load based on the first aggregation weight to generate a first modified rule set; and
processing the first cloud application using the first modified rule set to determine whether to deploy the first cloud application to the first cloud computing network.

3. The method of claim 2, wherein processing the first cloud application using the first modified rule set to determine whether to deploy the first cloud application to the first cloud computing network further comprises:
determining the first performance metric by processing the first cloud application using the first modified rule set;
determining a threshold metric for deploying the first cloud application; and
comparing the first performance metric to the threshold metric.

4. The method of claim 2, wherein processing the first cloud application using the first modified rule set to determine whether to deploy the first cloud application to the first cloud computing network further comprises:
determining the first performance metric by processing the first cloud application using the first modified rule set; and
weighting the first performance metric based on the first aggregation weight to determine a first weighted performance metric.

5. The method of claim 2, wherein processing the first cloud application using the first modified rule set to determine whether to deploy the first cloud application to the first cloud computing network further comprises:
determining a first weighted performance metric for the first cloud application based on weighting the first performance metric based on the first aggregation weight;
determining a second weighted performance metric for the first cloud application based on weighting a second performance metric based on a second aggregation weight; and
generating an aggregated performance metric based on aggregating the first weighted performance metric and the second weighted performance metric.

6. The method of claim 2, wherein processing the first cloud application using the first modified rule set to determine whether to deploy the first cloud application to the first cloud computing network further comprises:
determining a first weighted performance metric for the first cloud application based on weighting the first performance metric based on the first aggregation weight;
determining a second weighted performance metric for the first cloud application based on weighting a second performance metric based on a second aggregation weight; and
generating for display, in a user interface, a first visualization comprising the first weighted performance metric and the second weighted performance metric.

7. The method of claim 2, wherein processing the first cloud application using the first modified rule set to determine whether to deploy the first cloud application to the first cloud computing network further comprises:
determining the first performance metric by processing the first cloud application using the first modified rule set;
determining a first field in a first visualization corresponding to the first network requirement; and
populating the first field in the first visualization with the first performance metric.

8. The method of claim 2, wherein modifying the first required data load based on the first aggregation weight to generate the first modified rule set further comprises:
determining a first amount corresponding to the first required data load;
determining a reduction to the first amount based on the first aggregation weight; and
generating the first modified rule set based on the reduction to the first amount.

9. The method of claim 2, wherein generating the first modified rule set further comprises:
determining a first priority of the first required data feed;
determining a threshold priority based on the first aggregation weight; and
determining to modify the first required data feed to a second required data feed when generating the first modified rule set based on comparing the first priority to the threshold priority.

10. The method of claim 2, wherein generating the first modified rule set further comprises:
determining a first priority of the first required data feed;
determining a plurality of data feeds available based on the first priority; and
determining to modify the first required data feed to a second required data feed when generating the first modified rule set based on the first required data feed not being available based on the first priority.

11. The method of claim 2, wherein generating the first modified rule set further comprises:
determining a first network test, in the first rule set, for determining the first performance metric;
determining a threshold aggregation weight for performing the first network test; and
determining to perform the first network test based on determining that the first aggregation weight meets the threshold aggregation weight.

12. The method of claim 2, wherein generating the first modified rule set further comprises:
determining a first network test, in the first rule set, for determining the first performance metric;
determining a threshold aggregation weight for performing the first network test; and
determining to perform a second network test instead of the first network test based on determining that the first aggregation weight does not meet the threshold aggregation weight.

13. The method of claim 2, wherein generating the first modified rule set further comprises:
determining a first data type, in the first rule set, for determining the first performance metric;
determining a threshold aggregation weight for using the first data type; and
determining to use a second data type instead of the first data type based on determining that the first aggregation weight does not meet the threshold aggregation weight.

14. The method of claim 2, further comprising:
retrieving a second network requirement, from the plurality of network requirements, for the first cloud application;
determining a second rule set for the first network requirement, wherein the second rule set comprises a second required data feed, of the plurality of required data feeds, and a second required data load;
determining a second aggregation weight corresponding to a second performance metric for the second network requirement;
modifying the second required data load based on the second aggregation weight to generate a second modified rule set; and
processing the first cloud application using the second modified rule set to determine whether to deploy the first cloud application to the first cloud computing network.

15. The method of claim 2, wherein retrieving the plurality of network requirements for the first cloud application based on the first application category further comprises:
determining a first application characteristic corresponding to the first application category; and
determining the plurality of network requirements based on the first application characteristic.

16. One or more non-transitory, computer-readable media, comprising instructions that, when executed by one or more processors, cause operations comprising:
determining a first application category for a first cloud application;
retrieving a plurality of network requirements for the first cloud application, wherein respective performance metrics for each of the plurality of network requirements are aggregated according to predetermined aggregation weights to determine whether to deploy the first cloud application;
retrieving a first network requirement, from the plurality of network requirements, for the first cloud application;
determining a first rule set for the first network requirement, wherein the first rule set comprises a first required data feed, of a plurality of required data feeds, and a first required data load;
determining a first aggregation weight corresponding to a first performance metric for the first network requirement;
modifying the first required data load based on the first aggregation weight to generate a first modified rule set; and
processing the first cloud application using the first modified rule set to determine whether to deploy the first cloud application.

17. The one or more non-transitory, computer-readable media of claim 16, wherein processing the first cloud application using the first modified rule set to determine whether to deploy the first cloud application further comprises:
determining the first performance metric by processing the first cloud application using the first modified rule set;
determining a threshold metric for deploying the first cloud application; and
comparing the first performance metric to the threshold metric.

18. The one or more non-transitory, computer-readable media of claim 16, wherein processing the first cloud application using the first modified rule set to determine whether to deploy the first cloud application further comprises:
determining the first performance metric by processing the first cloud application using the first modified rule set; and
weighting the first performance metric based on the first aggregation weight to determine a first weighted performance metric.

19. The one or more non-transitory, computer-readable media of claim 16, wherein processing the first cloud application using the first modified rule set to determine whether to deploy the first cloud application further comprises:
determining a first weighted performance metric for the first cloud application based on weighting the first performance metric based on the first aggregation weight;
determining a second weighted performance metric for the first cloud application based on weighting a second performance metric based on a second aggregation weight; and
generating an aggregated performance metric based on aggregating the first weighted performance metric and the second weighted performance metric.

20. The one or more non-transitory, computer-readable media of claim 19, wherein processing the first cloud application using the first modified rule set to determine whether to deploy the first cloud application further comprises:
determining a first weighted performance metric for the first cloud application based on weighting the first performance metric based on the first aggregation weight;
determining a second weighted performance metric for the first cloud application based on weighting a second performance metric based on a second aggregation weight; and
generating for display, in a user interface, a first visualization comprising the first weighted performance metric and the second weighted performance metric.
